(19) United States
(12) Patent Application Publication
(10) Pub. No.: US 2007/0096696 A1
(43) Pub. Date: May 3, 2007

(54) System and method for charging a battery

(76) Inventors: Paul William Lefley, Leicester (GB); Jonathan Peter Starkey, Northants (GB)

Correspondence Address: HOFFMAN WARNICK & D'ALESSANDRO, LLC, 75 STATE STREET, 14TH FLOOR, ALBANY, NY, 12207, US

(21) Appl. No.: 10/563,141

(22) PCT Filed: Jun. 30, 2004
(86) PCT No.: PCT/GB04/02800

§ 371 Date: Jun. 5, 2006

(30) Foreign Application Priority Data
Jul. 1, 2003 (GB) 0315380.6

(51) Int. Cl. H02J 7/04

(52) U.S. Cl. 320/141

(57) ABSTRACT

A system and method for producing electrochemical conversion in an electrochemical device comprises a power converter, for example, a resonant circuit, connected to the electrochemical device and a triggering circuit connected to the power converter. The triggering circuit comprises a pulse generator to trigger the power converter to generate positive pulses of current for passing through the electrochemical device causing electrochemical conversion in the electrochemical device.

### CLAIM FOR PRIORITY

This application claims the benefit of United Kingdom patent application No. 0315380.6, filed Jul. 1, 2003, and PCT patent application No. PCT/GB2004/002800, filed 30 Jun. 2004, each of which is hereby incorporated by reference herein.

### FIELD OF THE INVENTION

The present invention relates to the field of battery charging and, more generally, to any electrochemical conversion technique, for example, electroplating.

### BACKGROUND OF THE INVENTION

Traditional methods of charging lead acid batteries employ the constant-current, constant-voltage charging algorithm whereby the battery is supplied with a constant current until the terminal voltage reaches a preset limit and charge is continued thereafter at a constant voltage. Consequently, a full recharge may take many hours, or sacrifice a large amount of electrolyte in order to speed up this process. In contrast, using a pulse charging technique has been shown to reduce significantly the time taken for a full recharge, without affecting battery life.

Conventional pulse charging schemes utilise a pulse current ratio typically of the order of 100 ms charge (“on”) time followed by 100 ms to 300 ms (“off”) settling time. However, it has been discovered that charge acceptance is a slow (diffusion) process in the battery. Therefore, to avoid excessive gassing, a much longer settling time is required compared with the charge time, especially when the battery is near fully charged. Furthermore, the charging rate is proportional to the average charging current. So, if a pulse charge is applied to the battery with a duty that favours long settling times, for example ten times the pulse “on” time, then the charging rate will be low and no significant advantage is gained over a normal trickle charge.

### SUMMARY OF THE INVENTION

The present invention takes the above to the extreme where the pulse current on time is of the order of fifty to one hundred microseconds (i.e. a thousand times shorter) with a magnitude of the order of a hundred times the level of current of a standard C₂₀ charge, this being the charge (or discharge) rate of current over a twenty hour period to completely charge (or discharge) the available capacity of the battery. The settling time may be of the order of 1 to 10 ms providing a pulse duty ratio of the order of 1:10 to 1:200.

The problem in achieving these very short, large magnitude current pulses is addressed by the power electronic converter embodying the present invention, which typically utilises a resonant technique.

The aim of the present invention is to provide a power converter that will generate a suitable pulse waveform for charging batteries.

Accordingly, this invention provides a power electronic topology that will enable the aforementioned pulse waveform to be produced.

According to a first aspect of the present invention there is provided a system for producing electrochemical conversion in an electrochemical device comprising:

a power converter connectable to the electrochemical device; and

a triggering circuit connectable to the power converter, the triggering circuit comprising a pulse generator to trigger the power converter to generate positive pulses of current for passing through the electrochemical device causing electrochemical conversion in the electrochemical device.

Preferably, the electrochemical device is a battery, a primary cell, for example a dry battery, a secondary cell, for example a lead acid battery, or an electroplating apparatus.

In a preferred embodiment, the resonant circuit is arranged to generate pulses of current having a duration of between around 50 to around 1000 microseconds. Preferably, the pulses of current have a substantially constant pulse width, the pulse width being controlled by the power converter.

In a preferred embodiment the pulses of current have an amplitude around one hundred times the amplitude of current required to charge or discharge completely the available capacity of the battery over a twenty hour period (C₂₀ charge).

Preferably, the electrochemical device has a settling time of around between 1 to 10 milliseconds to produce a duty cycle of around between 1:10 to around 1:200.

In a preferred embodiment the power converter comprises one or more pairs of inductor/capacitor combinations connectable as one or more series resonant circuits which are preferably low impedance.

Preferably, the power converter comprises at least two inductors and at least two capacitors to form two or more series resonant circuits in parallel, arranged such that the currents in the inductors are unidirectional and the currents in the capacitors are bidirectional.

Preferably, the windings of the at least two inductors are wound on a single core. Preferably, a first further winding is arranged on the core to form a step-down transformer. The further winding may be arranged to provide unidirectional current pulses to the electrochemical device via a rectifying diode.

In a preferred embodiment, further comprising a second further winding arranged on the core to form a demagnetisation winding.

Preferably, the triggering circuit comprises a pulse generator for producing firing current pulses for a number of thyristors connectable to the resonant circuit(s) and the pulse generator to control the charging and discharging of the power converter by switching between components of the power converter. The power converter may be arranged such that the current therethrough reverses in the second half of the oscillation cycle to turn off the thyristor(s).

In a preferred embodiment, the system further comprises a second pulse generator connectable to a second power converter, the second power converter being connectable to the electrochemical device for producing a negative current pulse between the positive current pulses generated by the first power converter for reducing the amount of gas produced in the electrochemical device due to the positive current pulses. The negative current pulse(s) have an energy content and the positive current pulse(s) have an energy content, the energy content of the negative current pulse(s) are preferably less than the energy content of the positive current pulse(s).

Preferably, the power converter comprises a resonant circuit.

According to a second aspect there is provided a method for producing electrochemical conversion in an electrochemical device comprising triggering a power converter to generate positive current pulses through the electrochemical device to produce the electrochemical conversion.

Preferably, the method for producing electrochemical conversion comprises producing electrochemical conversion in a system as defined above.

### BRIEF DESCRIPTION OF THE DRAWINGS

Preferred embodiments of the invention will now be described by way of example, and with reference to the accompanying drawings in which:

FIG. 1a is a circuit diagram of a configuration of a converter in accordance with an embodiment of the invention;

FIG. 1b is a graph of gate current against time showing typical gate firing pulses;

FIGS. 2a to 2f are circuit diagrams showing the modes of operation of a converter in accordance with an embodiment of the invention;

FIG. 3a is a typical battery current waveform;

FIG. 3b is a circuit diagram of a conventional flyback converter;

FIG. 3c is a circuit diagram of an alternative conventional flyback converter having a dual secondary winding on the transformer;

FIG. 4 is a circuit diagram of a first alternative embodiment of the invention;

FIG. 5 is a circuit diagram of a second alternative embodiment of the invention;

FIG. 6 is a circuit diagram of a third alternative embodiment of the invention;

FIG. 7 is a circuit diagram of a fourth alternative embodiment of the invention;

FIG. 8 is a circuit diagram of a fifth alternative embodiment of the invention;

FIG. 9 is a circuit diagram of a sixth alternative embodiment of the invention;

FIG. 10 is a circuit diagram showing a conventional circuit for charging dry batteries;

FIG. 11 is a graph showing the discharge of zinc carbon dry cells; and

FIG. 12 is a graph showing the charging of zinc carbon dry cells.

### DESCRIPTION OF PREFERRED EMBODIMENTS

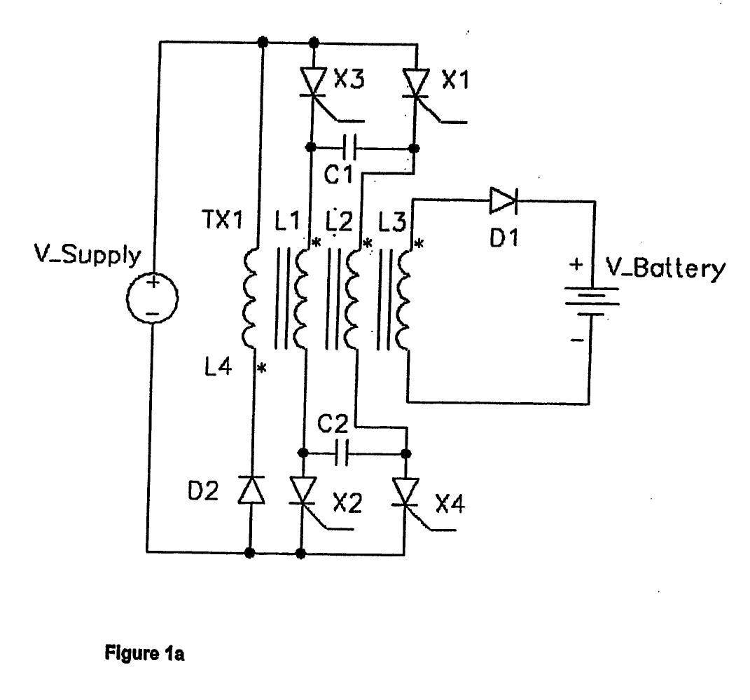

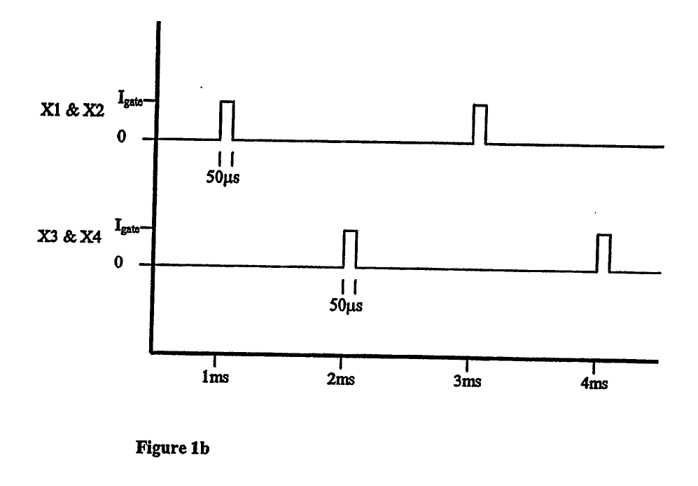

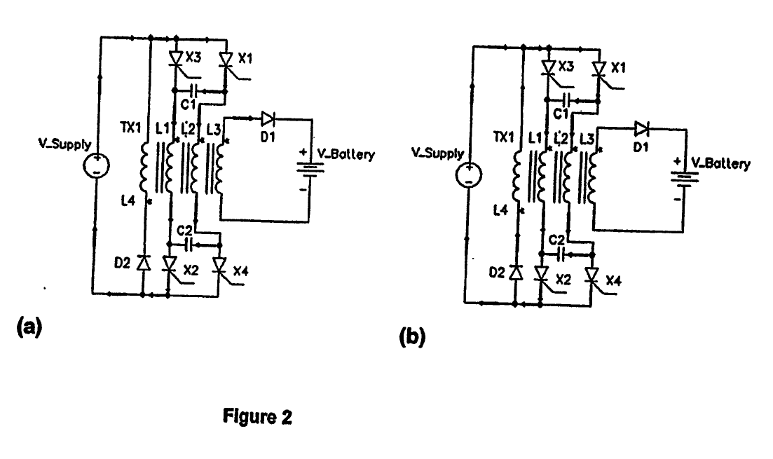

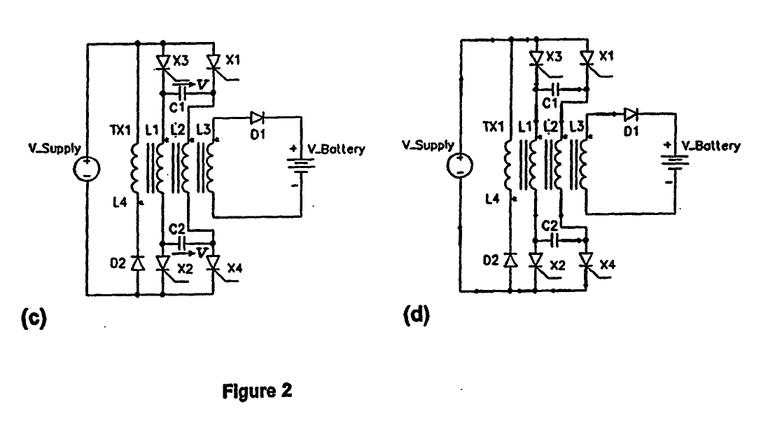

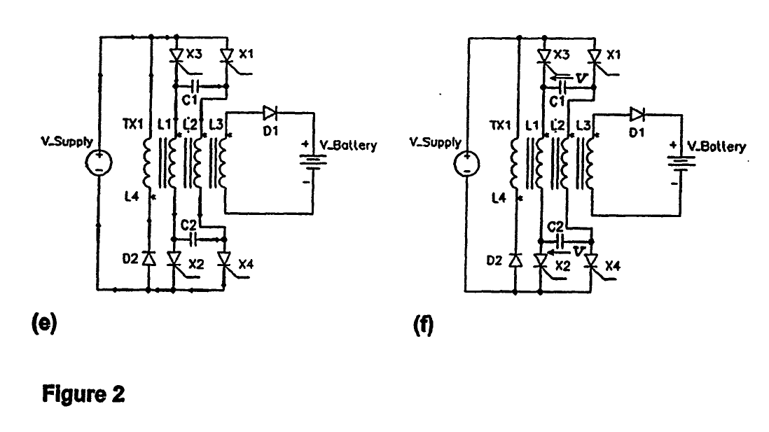

A first preferred embodiment of the invention is illustrated in FIGS. 1a to 2f. The circuit shown in these Figures comprises a transformer TX1 having four separate windings L1, L2, L3 and L4. L1 is connected through two thyristors X2 and X3, one at each end of the winding, to a DC supply voltage. L2 is similarly connected to the DC supply voltage through two thyristors X1 and X4. The first ends, for example the start, of the windings of L1 and L2 (designated by an ‘*’) are connected together via a capacitor C1, and the other ends of the windings of L1 and L2 are connected together via a second capacitor C2. The anodes of the thyristors X1 and X3 are connected to the positive terminal of the DC supply and the cathodes of X2 and X4 are connected to the negative terminal of the DC supply. The gates of the thyristors X1, X2, X3 and X4 are controlled by conventional pulse generators (not shown). Typical firing pulses for the gates of the thyristors X1, X2, X3 and X4 are shown in FIG. 1b. The gate pulse width will depend on the resonant pulse width employed, and the pulse repetition frequency will vary in relation to the operating pulse repetition frequency. The pulse amplitude I_{gate} must be set for the specific type of thyristor employed.

The first end, for example the start, of the winding of L3 is connected to the positive terminal of the battery under charge via a diode D1, and the other end of the winding of L3 is connected to the negative terminal of the battery under charge. The first end, for example, the start, of the winding of L4 is connected to the cathode of a diode D2, the anode of the diode D2 being connected to the negative terminal of the DC supply. The other end of the winding of L4 is connected to the positive terminal of the DC supply.

FIGS. 2a to 2f illustrate the modes of operation of the power converter illustrated in FIG. 1a. In particular, FIGS. 2a and 2b show progressive current flow in a first cycle at the end of which capacitors C1 and C2 are charged to a potential voltage as shown in FIG. 2c. FIGS. 2d to 2f show corresponding conditions for the next cycle in which the other pair of thyristors is switched.

In the preferred embodiment shown in FIGS. 1a to 2f, when switches X1 and X2 are closed for the first time, the full supply voltage initially exists across L1. As the two L-C arms C1, L1 and C2, L2 are in parallel for this cycle, operation of both arms will be identical. As the current through C1 and L1 increases (see FIG. 2a), so does the current in L3 being supplied to the battery, which goes to zero just before the voltages across L1 and L2 are zero. As the voltage across L1 decreases, through zero, becoming increasingly negative, the currents in L1 and L2 also decrease. L3 ceases to pass any current first, as once the battery voltage is greater than the voltage provided by the winding, the core is unable to discharge into the battery, but it does continue to discharge via L1 and L2 returning demagnetising energy back to C1 and C2.

The demagnetisation winding (L4) is included to discharge the core should the converter be operated with a high impedance load or indeed with no load at all, as in this case the high voltages produced across the resonant components would otherwise destroy these components as well as the thyristors.

During the next cycle, when X3 and X4 are fired, C1 and L2 form one series resonant pair. In addition to the full supply voltage, the voltage remaining across C1 from the previous resonant charging cycle (see FIGS. 2d-2f) also exists across L2. C2 and L1 form another resonant pair in parallel with C1 and L2. In this way, the voltage across L1 and L2 at the beginning of each pulse is much greater than the supply voltage. Operation continues in this manner with the thyristors being alternately switched in pairs.

It is not essential that the resonant capacitors (C1 and C2) be of equal value as the pulse width depends on the sum of their capacitances, rather than on their individual values. Likewise, the two resonant primary windings do not need to be identical, although operation is optimised in this case. The turns ratio on the transformer core is designed for each specific application, in order to give the correct step-up/step-down voltages and currents desired, as well as determining the primary inductance, which also affects the pulse width. Likewise, the demagnetisation winding (L4) may be omitted if the converter cannot be operated with a high impedance load, without any effect whatsoever on the operation of the converter, as it has been included to prevent the voltages across the resonant components from increasing to dangerous levels, and thus causing failure, should the converter be operated with a high impedance load.

The power converter embodying a first preferred embodiment of the present invention and as illustrated in FIGS. 1a to 2f is designed to produce current pulses of large amplitude and of low voltage magnitude. Therefore, for convenience, the step-down transformer TX1 is employed. As a constant pulse width is required, a resonant circuit is selected where the pulse width is controlled by the capacitor and inductor values selected. A series resonant circuit topology can have a relatively low impedance, enabling production of the large currents desired in the system embodying the present invention. This also has the advantage of enabling thyristors X1, X2, X3, X4 to be used as the semiconductor switches, due to the natural current commutation developed at switching frequencies below resonance, thus greatly simplifying the control of the converter.

In order to keep costs low and operation simple, only one high current Schottky type rectifying diode is included on the secondary side, meaning that unidirectional current in the transformer primary is essential (for operation with increased battery voltage, a synchronous rectifier may need to be substituted for the Schottky diode to maintain high efficiency). In order to fulfil this demand, two inductors L1, L2 and capacitors C1, C2 are used (effectively two series resonant circuits in parallel), arranged such that the currents in the inductors L1, L2 are unidirectional, whereas the currents in the capacitors C1, C2 are bi-directional (as shown in FIG. 1a). As both of the inductors L1, L2 are identical for reasons of symmetry, simplicity and increased efficiency, it is preferred that both of the inductor windings are included on the same core. The magnetising inductance of the step-down transformer TX1 is designed to be the resonant inductance, to reduce the component count, further simplifying the circuit. In order to prevent catastrophic failure should the circuit be accidentally operated without a load, a demagnetisation winding L4 is included on the transformer, which in effect configures the transformer as a forward converter. Also, with this circuit configuration, there are no problems with exceeding the di/dt or dv/dt rating of the devices, meaning that the power semiconductor switches can be snubberless.

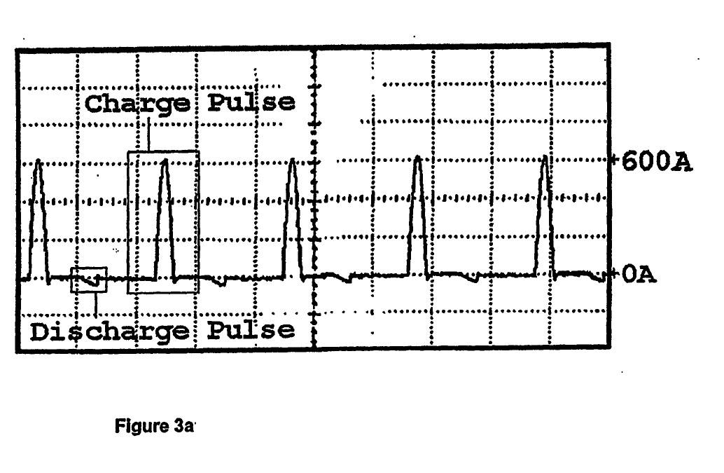

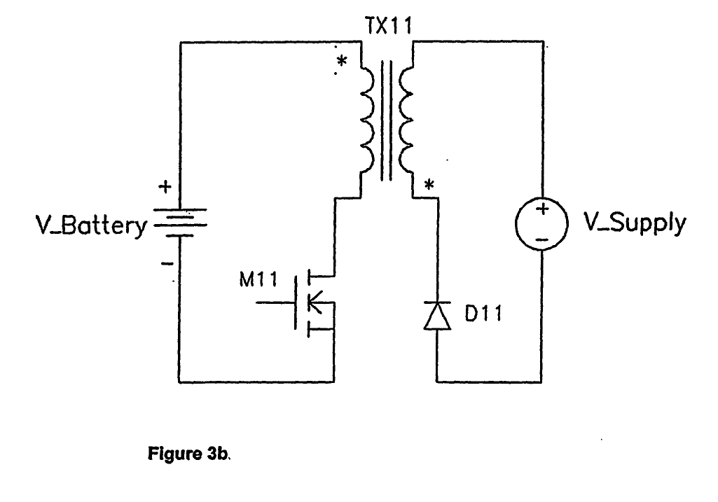

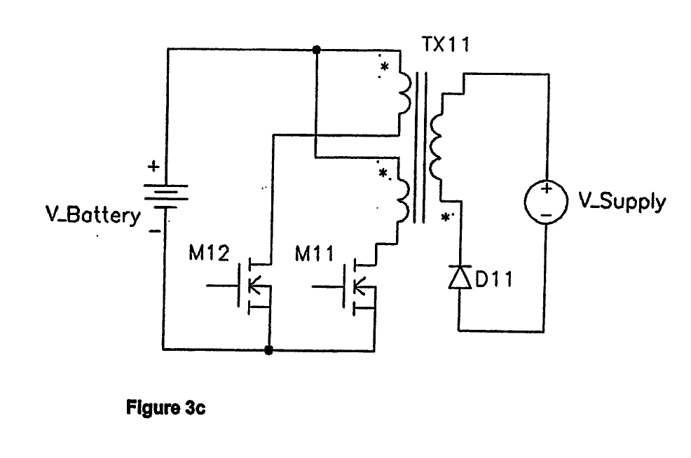

FIG. 3a shows a waveform of typical current pulses produced by the power converter illustrated in FIGS. 1a to 2f. The large positive charging current pulses (over 600 A peak in FIG. 3a) produced by the aforementioned power converter, are fed via the winding of L3 and the diode D1 to the battery under charge. In between the charge pulses, negative current (discharge) pulses are produced by a separate conventional fly-back converter connected to the battery under charge. Two alternative conventional fly-back converter configurations which are suitable for use in this context are shown in FIGS. 3b and 3c.

In the fly-back converter shown in FIG. 3b, the finish of the secondary winding of a transformer TX11 is connected to the positive terminal of a DC supply and the start of the winding is connected to the cathode of a diode D11, the anode of which is connected to the negative terminal of the DC supply. The start of the primary winding of the transformer TX11 is connected to the positive terminal of the battery under charge. The finish of the primary winding is connected to the drain of a field effect transistor M11. The source of the field effect transistor M11 is connected to the negative terminal of the battery under charge. The gate of the field effect transistor M11 is driven from a pulse generator (not shown).

In the alternative fly-back converter shown in FIG. 3c, the finish of the secondary winding of a transformer TX11 is connected to the positive terminal of a DC supply and the start of the winding is connected to the cathode of a diode D11, the anode of which is taken to the negative terminal of the DC supply. The transformer TX11 has two identical primary windings. The starts of the two primary windings are connected to the positive terminal of the battery under charge. The finish ends of the primary windings are taken to the drains of field effect transistors M11 and M12 respectively, the sources of the transistors being connected to the negative terminal of the battery under charge. The gates of the transistors M11 and M12 are connected to pulse generators (not shown).

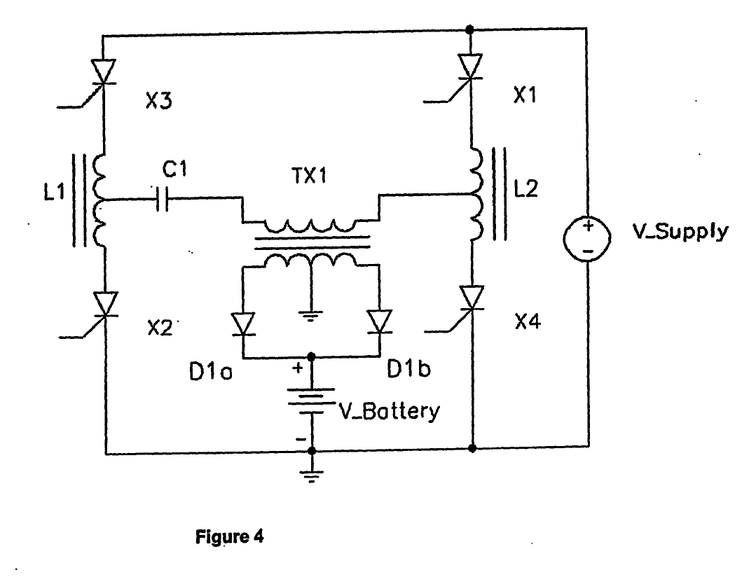

FIGS. 4 to 9 show alternative preferred embodiments to that described above and shown in FIGS. 1a to 2f. The circuit of FIG. 4 is built around four power semiconductors (thyristors X1, X2, X3, X4), arranged in an H-bridge configuration. The anode of X1 is connected to the positive terminal of the DC power supply, the cathode of X1 being connected to first end of the winding of a centre-tapped inductor L2. The other end of the winding of L2 is connected to the anode of X4. The cathode of X4 is connected to the negative terminal of the DC power supply. Thyristors X3 and X2 are connected in a similar manner to a second centre-tapped inductor L1.

The centre-tap of L1 is connected to one side of a first capacitor C1. The other side of the capacitor C1 is connected to one terminal of the primary winding of a transformer TX1. The other end of the primary winding of TX1 is connected to the centre-tap of L2.

The secondary winding of the transformer TX1 is centre-tapped, the tap being connected to the negative side of the DC power supply. The ends of the secondary winding are connected to the anodes of first and second diodes D1a, D1b. The cathodes of the diodes D1a and D1b are joined and are connected to the positive terminal of the battery under charge. The negative terminal of the battery under charge is connected to the negative terminal of the DC power supply. Alternatively the centre tap of the secondary winding and the negative terminal of the battery can be connected together and isolated from the power supply.

The centre-tapped inductors (L1 and L2) are included to limit the dv/dt and the di/dt experienced by the thyristors, and to ensure that the non-conducting thyristor pair are fully switched off. The operation of the circuit shown in FIG. 4 is similar to that described above in connection with FIGS. 1a to 2f, however, in the circuit of FIG. 4, the transformer/resonant inductor TX1 is designed with a centre tapped secondary in order to allow bi-directional excitation of the core, and thus improved efficiency, as a current pulse is produced off every switch of the thyristors, or in other words, two current pulses per switching cycle.

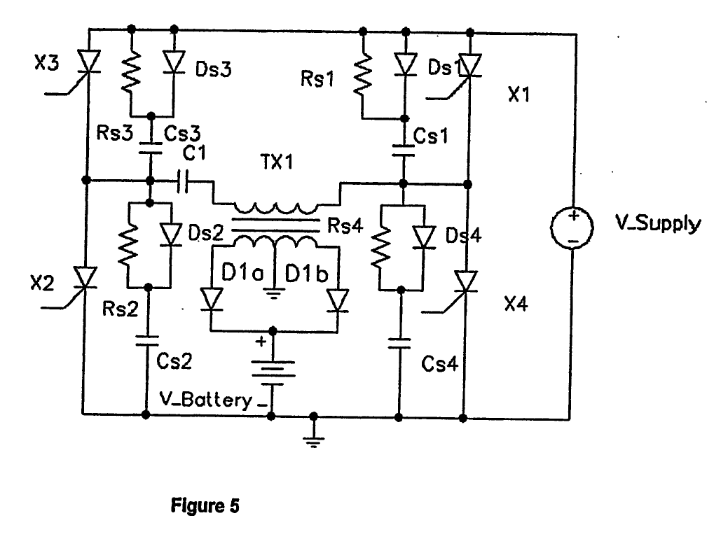

FIG. 5 shows a second alternative preferred embodiment comprising four thyristors X1, X2, X3, X4, a transformer TX1, six diodes D1a, D1b, Ds1, Ds2, Ds3, Ds4, five capacitors C1, Cs1, Cs2, Cs3, Cs4 and four resistors Rs1, Rs2, Rs3, Rs4. The anode of thyristor X1 is connected to the positive terminal of the DC power supply. The cathode of thyristor X1 is connected to the anode of thyristor X4. The cathode of thyristor X4 is connected to the negative terminal of the DC power supply. Thyristors X3 and X2 are similarly connected.

The cathode of X3 is connected to capacitor C1 and the other terminal of C1 is connected to one end of the primary of transformer TX1. The other end of the primary winding of transformer TX1 is connected to the cathode of the thyristor X1. The secondary winding of transformer TX1 is centre-tapped, the tapping being connected to the negative terminal of the DC power supply. The ends of the secondary winding are connected to the anodes of the diodes D1a and D1b respectively, the cathodes of D1a and D1b being joined and connected to the positive terminal of the battery under charge. The negative terminal of the battery under charge is connected to the negative terminal of the DC power supply.

The anode of diode Ds1 is connected to the positive terminal of the power supply and resistor Rs1 is connected in parallel with the diode Ds1. The cathode of diode Ds1 is connected to one terminal of the capacitor Cs1, the other terminal of Cs1 being connected to the cathode of thyristor X1.

A similar network comprising Ds2, Rs2 and Cs2 is connected across Thyristor X2.

Furthermore, a similar network comprising Ds3, Rs3 and Cs3 is connected across thyristor X3, and a similar network comprising Ds4, Rs4 and Cs4 is connected across thyristor X4.

The preferred embodiment shown in FIG. 5 is similar to the embodiment shown in FIG. 4 except that L1 and L2 have been omitted and replaced with four conventional snubbers (resistor, capacitor, diode network—e.g. Rs1, Cs1, Ds1 to Rs4, Cs4, Ds4). This requires careful selection of the components to prevent excessive power loss whilst still providing satisfactory protection to the thyristors. The operation of the circuit of FIG. 5 is the same as that shown in and described above with reference to FIG. 4.

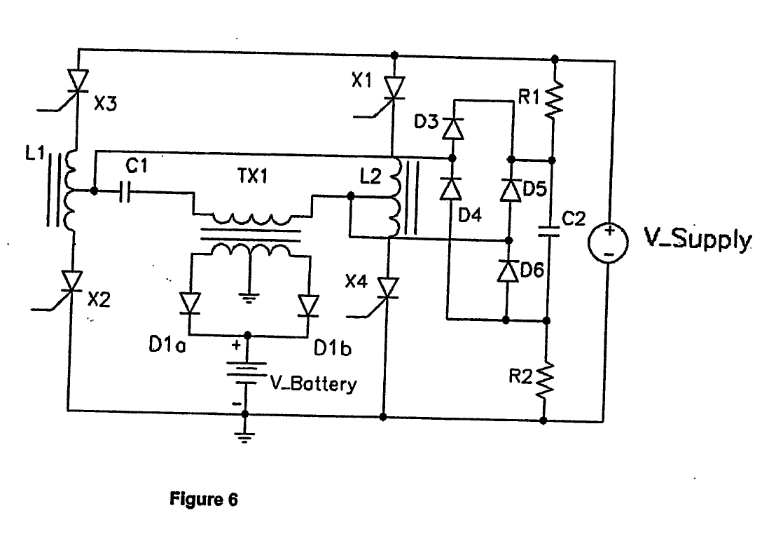

Another alternative preferred embodiment is shown in FIG. 6. The circuit of FIG. 6 is built around four power semiconductors (thyristors X1, X2, X3, X4), arranged in an H-bridge configuration. The anode of X1 is connected to the positive terminal of the DC power supply, the cathode of X1 being connected to a first end of the winding of a centre-tapped inductor L2. The other end of the winding of L2 is connected to the anode of X4. The cathode of X4 is connected to the negative terminal of the DC power supply. Thyristors X3 and X2 are connected in a similar manner to a second centre-tapped inductor L1.

The centre-tap of L1 is connected to one side of a first capacitor C1. The other side of the capacitor C1 is connected to one terminal of the primary winding of a transformer TX1. The other end of the primary winding of TX1 is connected to the centre-tap of L2.

The secondary winding of TX1 is centre-tapped, the tap being connected to the negative side of the DC power supply. The ends of the secondary winding are connected to the anodes of first and second diodes D1a, D1b. The cathodes of the diodes D1a and D1b are joined and are connected to the positive terminal of the battery under charge. The negative terminal of the battery under charge is connected to the negative terminal of the DC power supply.

A resistor R1 is connected in series with a capacitor C2 and a further resistor R2 across the power supply. The junction of R1 and C2 is connected to the cathodes of two diodes D3 and D4. The junction of R2 and C2 is connected to the anodes of diodes D4 and D6. The anode of D3 is connected to the cathode of D4 and also to the centre tap of the inductor L1. The anode of D5 is connected to the cathode of diode D6 and also to the centre tap of inductor L2.

The centre-tapped inductors (L1 and L2) are included to limit the dv/dt and the di/dt experienced by the thyristors, and to ensure that the non-conducting thyristor pair are fully switched off.

The embodiment shown in FIG. 6 is based on the embodiment shown in FIG. 5, but without the snubbers, and involves adding a “clamp” across the resonant L-C network, consisting of a bridge rectifier, a capacitor and a “bleed” resistor back to the power supply. This offers improved performance although the resistor size is dependent upon the supply voltage used.

Suitable values for R1 and R2 need to be obtained to match the power flow into the capacitor to the power flow back to the supply. The operation of the circuit of FIG. 6 is substantially the same as that described above and illustrated in FIG. 4.

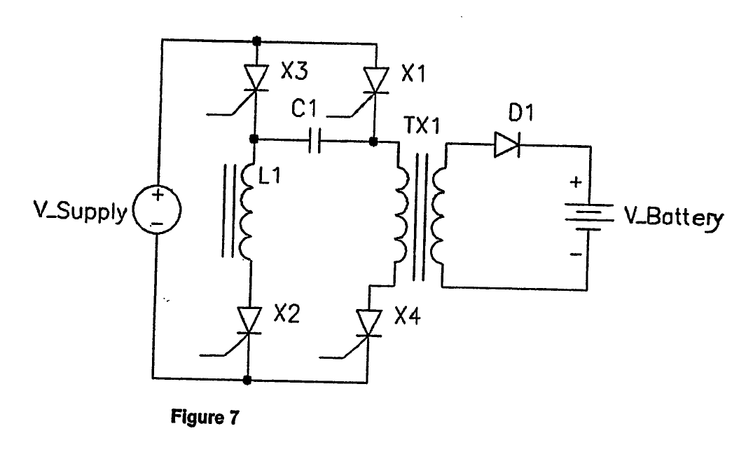

A further alternative preferred embodiment is shown in FIG. 7. In this embodiment, the power charger includes four thyristors X1, X2, X3, X4, a diode D1, a capacitor C1, an inductor L1, and a transformer TX1. The anode of thyristor X1 is connected to the positive terminal of the power supply. The cathode of X1 is connected to one terminal of capacitor C1 and to one terminal of the primary winding of the transformer TX1. The other terminal of the primary winding of the transformer TX1 is connected to the anode of thyristor X4. The cathode of thyristor X4 is connected to the negative terminal of the DC power supply. The anode of thyristor X3 is connected to the positive terminal of the DC power supply. The cathode of thyristor X3 is connected to the other terminal of C1 and to one terminal of the inductor L1. The other terminal of L1 is connected to the anode of thyristor X2, the cathode of thyristor X2 being connected to the negative terminal of the DC power supply.

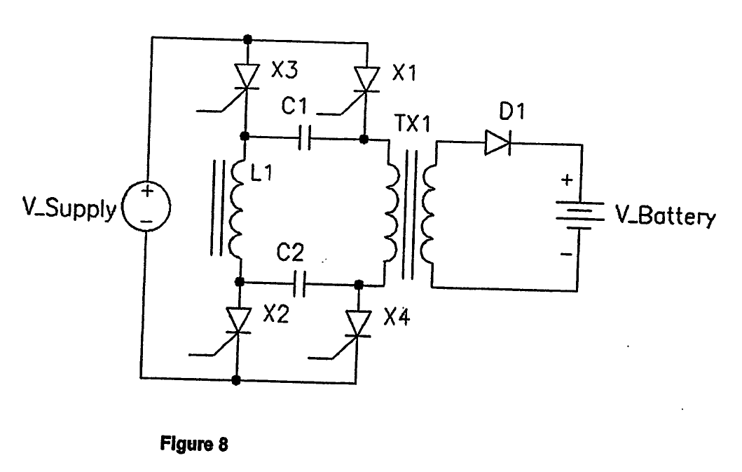

One terminal of the secondary winding of the transformer TX1 is connected to the anode of diode D1 and the cathode of diode D1 is connected to the positive terminal of the battery under charge. The other terminal of the secondary winding of the transformer TX1 is connected to the negative terminal of the battery under charge. In order to reduce the component count, the circuit of FIG. 7 differs from that of FIG. 6 in that current now exists in only one direction in the primary winding of the transformer TX1, resulting in a unidirectional secondary current. In order to supply the transformer TX1 with unidirectional current, its position in the circuit is altered as shown in FIG. 7, but in order to maintain the resonant charging of the capacitor C1, inductor L1 is included to conduct on alternate half-cycles, that is when the second pair of thyristors are fired. This circuit will only provide half the number of current pulses that the previous variants shown in FIGS. 1a to 6 have been able to provide. A further alternative preferred embodiment is shown in FIG. 8. The operation of the circuit of FIG. 8 is substantially the same as that described above and illustrated in FIG. 7. The circuit of FIG. 8 is identical to that described above with regard to FIG. 7 with the exception that a second resonant capacitor C2 is included to improve the circuit symmetry and charging of the resonant components, although this does increase the component count. Capacitor C2 is connected between the anode of thyristor X4 and the anode of thyristor X2.

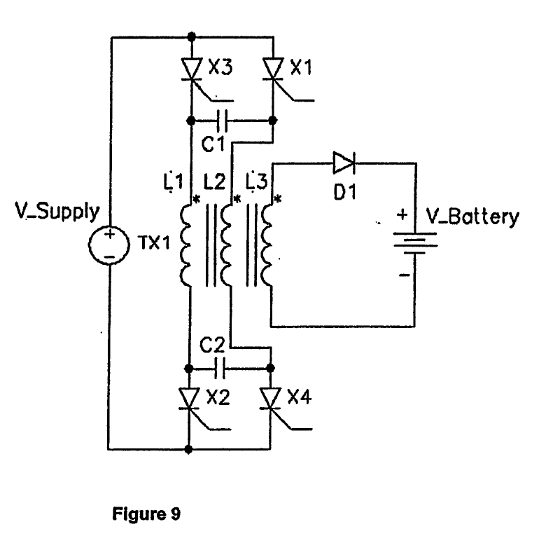

A further alternative embodiment is shown in FIG. 9. The circuit comprises a transformer TX1 having three windings L1, L2, and L3. L1 is connected through two thyristors X2 and X3, one at each end of the winding, to a DC supply voltage. L2 is similarly connected to the DC supply voltage through two thyristors X1 and X4. The first ends, for example the start, of the windings of L1 and L2 are connected together via a capacitor C1, and the other ends of the windings of L1 and L2 are connected together via a second capacitor C2. The anodes of the thyristors X1 and X3 are connected to the positive terminal of the DC supply and the cathodes of X2 and X4 are connected to the negative terminal of the DC supply. The gates of the thyristors X1, X2, X3 and X4 are controlled by conventional pulse generators (not shown). Typical firing pulses for the gates of the thyristors X1, X2, X3 and X4 are shown in FIG. 1b. As mentioned above in respect of the preferred embodiment illustrated in FIG. 1a, the gate pulse width will depend on the resonant pulse width employed, and the pulse repetition frequency will vary in relation to the operating pulse repetition frequency. The pulse amplitude I_{gate} must be set for the specific type of thyristor employed.

The first end, for example the start, of the winding of L3 is connected to the positive terminal of the battery under charge via a diode D1, and the other end of the winding of L3 is connected to the negative terminal of the battery under charge. The circuit of FIG. 9 differs from that shown in FIG. 8 in that the separate inductor L1 is not present in the circuit of FIG. 9. This has the effect of reducing the component count and is achieved by including all of the inductors on the same core. Again, double the number of current pulses are available per switching cycle, as a current pulse is available for each switching of a pair of thyristors (as in the embodiment of FIG. 4). However, in certain circumstances the reverse voltage across the secondary rectifying diode D1 has been found to increase to dangerous levels (for the diode) as the supply voltage is increased. In order to combat this, a demagnetising winding, L4 in conjunction with D2, can be included, as shown in FIG. 1a, as the negative voltage only appears across the diode while both the core is demagnetising and the secondary current has ceased. This may be a problem if the diode used is a Schottky type. Such a diode may be selected as it has a low forward voltage drop, which at high current levels enables greater levels of efficiency to be achieved. The operation of the circuit of FIG. 9 is substantially the same as that described above and illustrated in FIG. 1a.

In summary, the power electronic converter embodying the present invention, preferably, utilises a resonant technique and very short high magnitude current pulses. When using the converter, it has been determined that such current pulses can affect the morphology of the converted ions either from the electrolyte or from within the plate into the chemically charged state on the anode (or cathode). The morphology changes depend on the level of charging current. Low levels of continuous current promote large crystalline growth of the deposit on the plate, whereas very short, high magnitude pulses of current promote small granular growth. This is seen as an advantage as the granular morphology of the battery plates will yield a higher ampere-hour capacity. Therefore, a “tired” battery charged in this way may recover some of its lost capacity. Although gassing of the battery may be reduced by allowing a relatively large settling time to occur between the charge pulses, gassing may be further reduced by the addition of a discharge pulse to occur either before or after the charging pulse. The magnitude or more specifically the current-time product of the discharge pulse is a percentage of the current-time product of the charge pulse. Charging and discharging affects the anode potential of the lead-acid cell relatively to a standard hydrogen reference electrode that may be in contact with the electrolyte. Charging the cell raises the anode potential whilst discharging lowers the anode potential. A similar effect may be found at the cathode. It is understood that gassing is more likely to occur if the anode has a relatively high positive potential, and so the addition of the discharge pulse momentarily lowers the anode potential before (or after) the main charging pulse is injected, thus further reducing the onset of gassing. This discharge pulse is generated by a separate power converter. As discussed above, this power converter is based on a flyback converter, which is able to return the discharge energy from the battery back to the power supply to maintain charger efficiency. Other types of dc-dc converters could be used for the discharge function.

While the present invention has been described with reference to specific embodiments, those skilled in the art will recognise that changes in form and detail may be made without departing from the invention. For example, although the converter was designed initially to use thyristors as the semiconductor switches, it is apparent that the operation of the converter would be unchanged should these components be replaced with other types of switch, for example IGBTs, MOSFETs or BJTs. Likewise, for operation at voltage levels for which using a Schottky diode (or diodes) would not be feasible, any other type of rectifier may be substituted, including synchronous rectifiers, without departing from the invention. The transformer core can be made of any suitable material, for example, laminated iron, iron powder or ferrite, with various air-gaps depending on the type chosen. The resonant inductances formed by L1 and L2 may also be formed using separate series inductors not included on the transformer core, without affecting operation of the circuit. The addition of transient voltage suppressors across the thyristors for added protection also will not change the operation of the power converter. Furthermore, anti-parallel diodes across X1 to X4 could be included for added protection if deemed necessary.

The power converter is designed primarily to be used for pulse battery charging. However, it could be equally well applied to any situation requiring a similar waveform, for example pulse electro-deposition.

With the addition of suitable smoothing components, as used in standard power supplies, this circuit could even be used to produce a variable, regulated, current controlled DC output, without departing from the power converter of the invention. The majority of the above embodiments would operate equally well in the half-bridge configuration.

The above-described preferred embodiments may also be used in the pulse charging of dry batteries (zinc carbon type).

The standard carbon zinc chloride type of battery comes under the general classification of primary cells. Primary cells are designed to corrode electrochemically during their normal life. The rate of corrosion increases when being discharged. They are not intended to be recharged, but the presence of manganese dioxide (i.e. the positive plate) allows the cell to recover to some extent for re-use.

It is known that dry cells can be recharged but not as effectively as storage batteries. The conventional technique for recharging dry cells typically utilises a succession of charge/discharge cycles accomplished with a direct current containing an alternating current component. This may be achieved using a standard half-wave rectifier charger with a rectifier bypass resistor to allow partial discharge on every other half cycle.

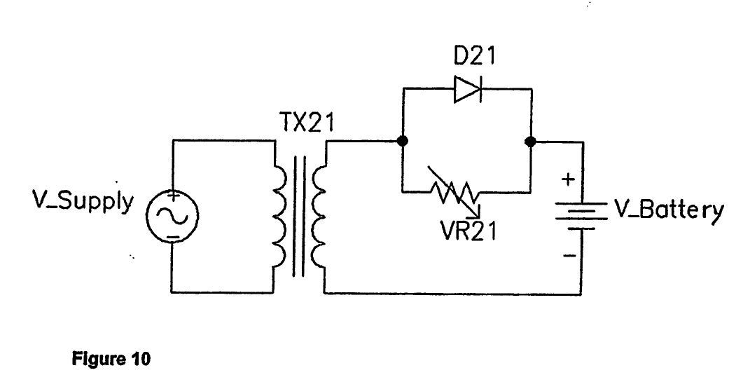

FIG. 10 shows a typical circuit for charging dry batteries. The primary winding of a transformer TX21 is connected to an AC supply. One end the secondary winding of transformer TX21 is connected to the anode of a diode D21 and also to one end of a variable resistor VR21. The other terminal of the variable resistor VR21 is connected to the cathode of diode D21 and also to the positive terminal of the battery under charge. The negative terminal of the battery under charge is connected to the other end of the secondary winding of the transformer TX21.

In operation, the output of transformer TX21 is rectified on the positive half-cycle by diode D21 and when the voltage on the cathode of the diode D21 exceeds the voltage on the positive terminal of the battery under charge, current flows into the battery to charge the battery. Some current will also flow through the variable resistor VR21. On the negative half-cycles, no current flows through diode D21 as it is reverse biased, but a discharge current will be drawn from the battery via the variable resistor VR21. The discharge current will be determined by the output voltage of transformer TX21 and the value of the variable resistor VR21.

Recharging a battery in this way can be fraught with problems. Prolonged charging can lead to the decomposition of the electrolyte allowing a build up of gas, which may cause the outer casing to burst. To avoid these problems various limits for this type of charging include: the charging voltage must not exceed 1.7 volts/cell, and the charge current should lie between 25 and 75% of the discharge current with a 50% current times time overcharge. However, the Applicant has determined that the maximum cell voltage during charging can be exceeded if applied for a very short duration, followed by a discharge pulse with a current time product less than that of the charging pulse. The benefits include a faster recharge and improved charge acceptance.

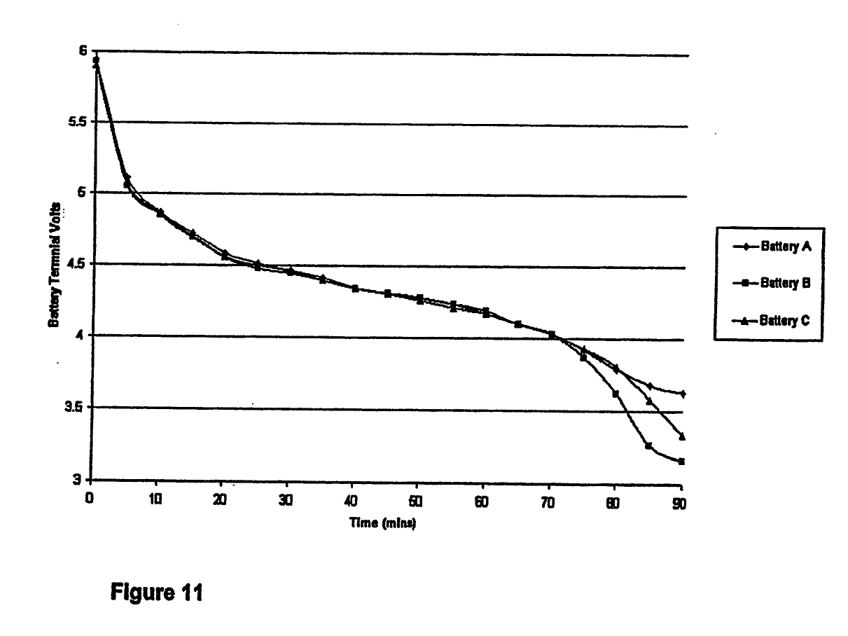

An experiment has been conducted to assess the effectiveness of pulse charging dry cells of the zinc-carbon type. Three unused (PJ996 type) 11 Ahr, 6V batteries (from the same manufactured batch) were discharged with the same series discharge current of 1 A (nominal) for 2 hours. The discharge curves are shown in FIG. 11. The three batteries (individually marked ‘A’, ‘B’ and ‘C’) were subject to the following: Battery A, was not given any charge and allowed to recover naturally. Battery B, was given a pulse charge current of 0.75 A average for 3 hours where the pulse amplitude was 25 A peak and of 85 μs duration. Battery C was given a constant DC charging current of 0.75 A for 3 hours.

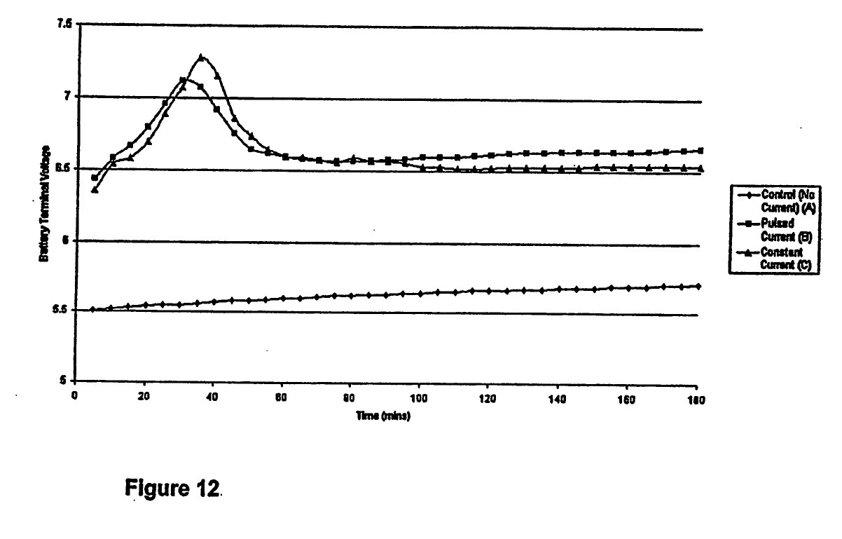

The graphs showing the terminal voltages for each battery during recharge are shown in FIG. 12. Battery A shows a constant rate of recovery. Battery C shows a rapid increase in terminal voltage which, after rising to a peak voltage of 7.3 volts, settles down to 6.5 volts for the remainder of the charging period. Battery B also shows a rapid increase in terminal voltage, the peak voltage being lower at 7.1 volts and occurring 5 minutes earlier. Furthermore, as the charging progresses the terminal voltage falls to 6.5V as with Battery C, but the voltage then continues to rise at the same rate as Battery A.

After 3 days the terminal voltages were:

Battery A: 5.92 volts Battery B: 6.03 volts Battery C: 5.90 volts

The cells were discharged again to establish how much charge Batteries B and C may have acquired. After a repeated number of charge/discharge cycles the measured ampere-hour capacity for each battery was:

Battery A: 8.0 Ah Battery B: 10.7 Ah Battery C: 9.5 Ah.

From the above experiments it can be concluded that pulse charging of dry cells using very short high magnitude pulses does allow dry cells to recuperate more effectively than with a constant current charge. The preferred embodiments of the invention illustrated in FIGS. 1a to 9 and described above would therefore be suitable for charging dry cells of the zinc carbon type.

1. A system for producing electrochemical conversion in an electrochemical device comprising:
a power converter connectable to the electrochemical device; and
a triggering circuit connectable to the power converter, the triggering circuit comprising a pulse generator to trigger the power converter to generate positive pulses of current for passing through the electrochemical device causing electrochemical conversion in the electrochemical device.

2. A system according to claim 1, wherein the electrochemical device is a battery.

3. A system according to claim 1, wherein the electrochemical device is a primary cell, for example a dry battery.

4. A system according to claim 1, wherein the electrochemical device is a secondary cell, for example a lead acid battery.

5. A system according to claim 1, wherein the electrochemical device is an electroplating apparatus.

6. A system according to claim 1, wherein the power converter is arranged to generate pulses of current having a duration of between around 50 to around 1000 microseconds.

7. A system according to claim 1, wherein the pulses of current have a substantially constant pulse width, the pulse width being controlled by the power converter.

8. A system according to claim 1, wherein the pulses of current have an amplitude around one hundred times the amplitude of current required to charge or discharge completely the available capacity of the battery over a twenty hour period (C₂₀ charge).

9. A system according to claim 1, wherein the electrochemical device has a settling time of between around 1 to 10 milliseconds to produce a duty cycle of between around 1:10 to around 1:200.

10. A system according to claim 1, wherein the power converter comprises one or more pairs of inductor/capacitor combinations connectable as one or more series resonant circuits.

11. A system according to claim 10, wherein the power converter has a low impedance.

12. A system according to claim 1, wherein the power converter comprises at least two inductors and at least two capacitors to form two or more series resonant circuits in parallel, arranged such that the currents in the inductors are unidirectional and the currents in the capacitors are bidirectional.

13. A system according to claim 12, wherein the windings of the at least two inductors are wound on a single core.

14. A system according to claim 13, wherein a first further winding is arranged on the core to form a step-down transformer.

15. A system according to claim 14, wherein the further winding is arranged to provide unidirectional current pulses to the electrochemical device via a rectifying diode.

16. A system according to claim 14, further comprising a second further winding arranged on the core to form a demagnetisation winding.

17. A system according to claim 1, wherein the triggering circuit comprises a pulse generator for producing firing current pulses for a number of thyristors connectable to the power converter and the pulse generator to control the charging and discharging of the resonant circuits(s) by switching between components of the resonant circuit(s).

18. A system according to claim 17, wherein the power converter is arranged such that the current therethrough reverses in the second half of the oscillation cycle to turn off the thyristor(s).

19. A system according to claim 1, wherein the system further comprises a second pulse generator connectable to a second power converter, the second power converter being connectable to the electrochemical device for producing a negative current pulse between the positive current pulses generated by the first power converter for reducing the amount of gas produced in the electrochemical device due to the positive current pulses.

20. A system according to claim 19, wherein the negative current pulse(s) have an energy content and the positive current pulse(s) have an energy content, the energy content of the negative current pulse(s) being less than the energy content of the positive current pulse(s).

21. A system according to claim 1, wherein the power converter comprises a resonant circuit.

22. A method for producing electrochemical conversion in an electrochemical device comprising triggering a power converter to generate positive current pulses through the electrochemical device to produce the electrochemical conversion.

23. A method for producing electrochemical conversion in a system according to claim 1.

24.-25. (canceled)
